(19) United States
(12) Patent Application Publication
(10) Pub. No.: US 2025/0198752 A1
(43) Pub. Date: Jun. 19, 2025

(54) DEVICE

(71) Applicant: TOYOTA JIDOSHA KABUSHIKI KAISHA, Toyota-shi (JP)

(72) Inventors: Daiki YOKOYAMA, Miyoshi-shi (JP); Mikihiro Moriyama, Toyota-shi (JP); Jyunya Katou, Toyota-shi (JP)

(73) Assignee: TOYOTA JIDOSHA KABUSHIKI KAISHA, Toyota-shi (JP)

(21) Appl. No.: 18/944,646

(22) Filed: Nov. 12, 2024

(30) Foreign Application Priority Data
Dec. 14, 2023 (JP) 2023-210675

(51) Int. Cl. G01B 21/16

(52) U.S. Cl. CPC G01B 21/16

(57) ABSTRACT

A device includes a motion information acquisition unit that acquires motion information regarding a motion state of an apparatus interlocked with a moving body that is movable by unmanned operation, and a calculation unit that calculates at least one of a position and a direction of the moving body using the acquired motion information.

### CROSS-REFERENCE TO RELATED APPLICATION

This application claims priority to Japanese Patent Application No. 2023-210675 filed on Dec. 14, 2023, incorporated herein by reference in its entirety.

### BACKGROUND

### 1. Technical Field

The present disclosure relates to a device.

### 2. Description of Related Art

Japanese Unexamined Patent Application Publication No. JP 2015-074321 (JP 2015-074321 A) discloses technology that captures an image of a vehicle by using a camera outside the vehicle, and uses the captured image by the camera for automatic traveling of the vehicle.

### SUMMARY

Technology can be used, when a moving body such as a vehicle is moved by an unmanned operation, that acquires a position and an orientation of the moving body based on a result of detecting the moving body by an external sensor positioned outside the moving body. However, for example, when there is an obstacle between the external sensor and the moving body, there is a risk that the moving body cannot be appropriately detected by the external sensor, and a position and an orientation of the moving body cannot be appropriately acquired.

The present disclosure is capable of being realized as the following embodiment.

According to one aspect of the present disclosure, a device is provided. the device includes a motion information acquisition unit that acquires motion information related to a motion state of an apparatus interlocked with a moving body that is movable by an unmanned operation, and a calculation unit that calculates at least one of a position and an orientation of the moving body by using the acquired motion information.

According to the aspect, a position and an orientation of the vehicle can be appropriately acquired, even in a situation where appropriate detection of the vehicle by the external sensor can be hindered.
In the aspect, the device may further include
a specification unit that specifies the apparatus, in which
the motion information acquisition unit may acquire the motion information for the apparatus specified by the specification unit.
   According to the aspect, motion information of an interlocked apparatus can be more appropriately acquired.
   In the aspect,
the calculation unit may calculate at least one of a position and an orientation of the moving body by using a detection result of the moving body by an external sensor positioned outside the moving body when an interlocked state in which the apparatus and the moving body are interlocked transitions to a non-interlocked state in which the apparatus and the moving body are not interlocked.
   According to the aspect, not only can vehicle position information be appropriately acquired in an interlocked state, but also vehicle position information can be appropriately acquired even when the interlocked state transitions to a non-interlocked state.
   In the aspect,
the device may further include a search unit that executes a search of an apparatus that moves interlocked with the moving body when an interlocked state in which the apparatus and the moving body are interlocked transitions to a non-interlocked state in which the apparatus and the moving body are not interlocked.
   According to the aspect, an interlocked apparatus interlocked with the vehicle can be newly searched, and vehicle position information can be calculated by using motion information of the searched interlocked apparatus, even when an interlocked state transitions to a non-interlocked state.
   In the aspect,
the calculation unit may calculate at least one of a position and an orientation of the moving body by using a detection result of the moving body by an external sensor positioned outside the moving body when an apparatus that moves interlocked with the moving body is not specified by the search.
   According to the aspect, in a search when an interlocked state transitions to a non-interlocked state, vehicle position information can be appropriately acquired, even when an apparatus that moves interlocked with a moving body is not specified.
   The present disclosure can be realized, for example, in the form of a system, a control method, a program, a non-transitory recording medium on which a program is recorded, a program product or the like, in addition to the aspect of the device. The program product may be provided as, for example, a recording medium on which a program is recorded, or may be provided as a program product capable of being distributed via a network.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a configuration of a system according to a first embodiment;

FIG. 2 is a block diagram illustrating a configuration of a system according to the first embodiment;

FIG. 3 is a diagram illustrating an interlocked state in the first embodiment;

FIG. 4 is a diagram illustrating an example of an apparatus database;

FIG. 5 is a flowchart illustrating a processing procedure of travel control of a vehicle according to the first embodiment;

FIG. 6 is a flowchart illustrating a processing procedure of the command generation processing according to the first embodiment;

FIG. 7 is a block diagram illustrating a configuration of a system according to a second embodiment;

FIG. 8 is a diagram illustrating an interlocked state in the second embodiment;

FIG. 9 is a flowchart of a command generation process according to the second embodiment;

FIG. 10 is a flowchart of a command generation process according to the third embodiment;

FIG. 11 is a block-diagram showing a configuration of a system according to a fourth embodiment; and

FIG. 12 is a flowchart illustrating a processing procedure of travel control of the vehicle according to the fourth embodiment.

### DETAILED DESCRIPTION OF EMBODIMENTS

### A. First Embodiment

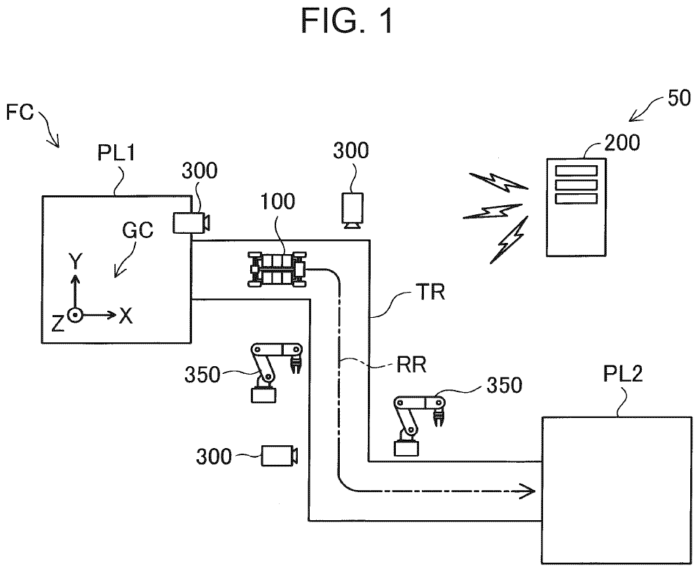

FIG. 1 is a conceptual diagram illustrating a configuration of a system 50 according to a first embodiment. The system 50 includes one or more vehicles 100, a server 200, one or more external sensors 300, and an external apparatus 350. The server 200 in the first embodiment corresponds to a “device” in the present disclosure.

The vehicle 100 may be a vehicle traveling by a wheel or a vehicle traveling by an infinite track, and is, for example, a passenger car, a truck, a bus, a two-wheeled vehicle, a four-wheeled vehicle, a tank, a construction vehicle, or the like. In the present embodiment, the vehicles 100 are battery electric vehicles (BEVs). The vehicles 100 may be, for example, gasoline-powered vehicles, hybrid electric vehicles, or fuel cell electric vehicles.

The vehicle 100 is configured to be able to travel by unmanned operation. The term “unmanned operation” means driving that does not depend on the traveling operation of the passenger. The traveling operation means an operation related to at least one of “running”, “turning”, and “stopping” of the vehicle 100. The unmanned operation is realized by automatic or manual remote control using a device located outside the vehicle 100 or by autonomous control of the vehicle 100. A passenger who does not perform the traveling operation may be on the vehicle 100 traveling by the unmanned operation. The passenger who does not perform the traveling operation includes, for example, a person who is simply seated on the seat of the vehicle 100 and a person who performs a work different from the traveling operation such as an assembling operation, an inspection operation, and an operation of switches while riding on the vehicle 100. Driving by the traveling operation of the occupant is sometimes referred to as “manned driving”.

In the present disclosure, “remote control” includes “full remote control” in which all of the operations of the vehicle 100 are completely determined from the outside of the vehicle 100, and “partial remote control” in which a part of the operations of the vehicle 100 is determined from the outside of the vehicle 100. Further, “autonomous control” includes “fully autonomous control” in which the vehicle 100 autonomously controls its operation without receiving any information from a device external to the vehicle 100, and “partially autonomous control” in which the vehicle 100 autonomously controls its operation using information received from a device external to the vehicle 100.

The vehicle 100 may be provided with a configuration that can be moved by unmanned operation, and may be, for example, in the form of a platform having a configuration described below. Specifically, the vehicle 100 may include at least a vehicle control device and an actuator group, which will be described later, in order to perform three functions of “running,” “turning,” and “stopping” by unmanned operation. When information is acquired from a device outside the vehicle 100 for unmanned operation, the vehicle 100 may further include a communication device. That is, in the vehicle 100 that can be moved by the unmanned operation, at least a part of the interior components such as the driver's seat and the dashboard may not be mounted, at least a part of the exterior components such as the bumper and the fender may not be mounted, and the body shell may not be mounted. In this instance, the remaining components, such as the body shell, may be mounted to the vehicle 100 until the vehicle 100 is shipped from the factory FC. In addition, while the remaining components such as the body shell are not mounted on the vehicle 100, the remaining components such as the body shell may be mounted on the vehicle 100 after the vehicle 100 is shipped from the factory FC. Each of the components may be mounted from any direction, such as the upper side, lower side, front side, rear side, right side, or left side of the vehicle 100, each may be mounted from the same direction, or may be mounted from a different direction.

In the present embodiment, the system 50 is used in a factory FC that manufactures the vehicles 100. The reference coordinate system of the factory FC is a global coordinate system GC, and any position in the factory FC can be represented by the coordinates of X, Y, Z in the global coordinate system GC. The factory FC includes a first location PL1 and a second location PL2. The first location PL1 and the second location PL2 are connected by a track TR on which the vehicles 100 can travel. In the factory FC, a plurality of external sensors 300 is installed along the track TR. The positions of the external sensors 300 in the factory FC are adjusted in advance. The vehicles 100 travel through the track TR from the first location PL1 to the second location PL2 by unmanned operation. In the present embodiment, the vehicles 100 are in the form of platforms while moving from the first location PL1 to the second location PL2. In other embodiments, the vehicle 100 may be in the form of a completed vehicle, not limited to a platform.

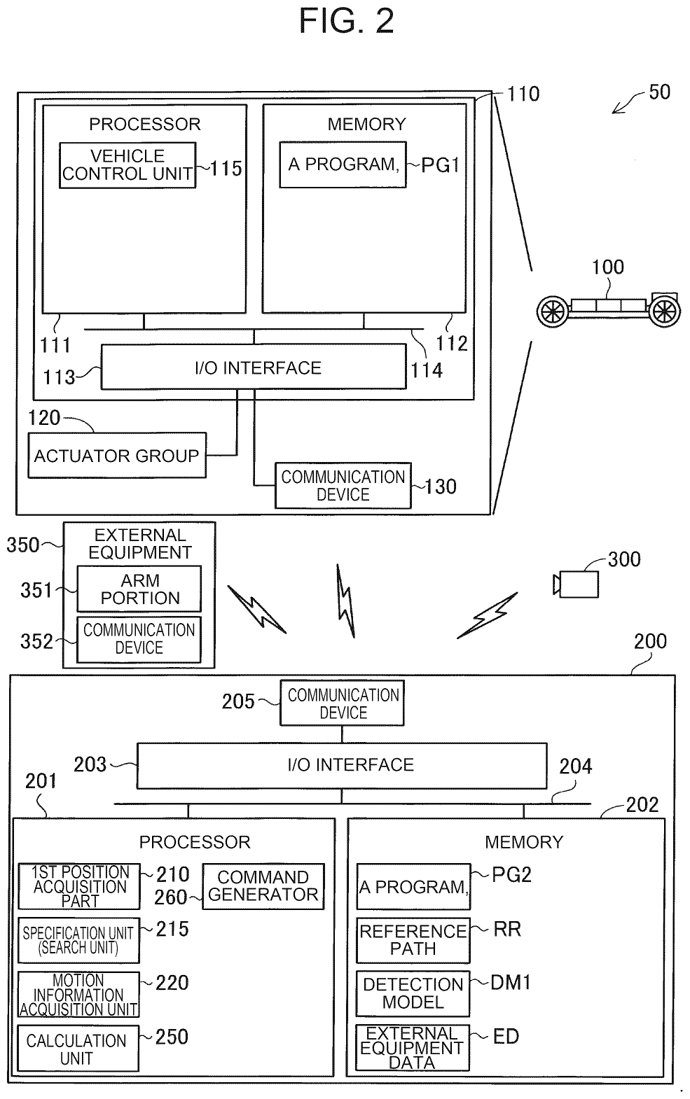

FIG. 2 is a block diagram illustrating a configuration of the system 50. The vehicle 100 includes a vehicle control device 110 for controlling each unit of the vehicle 100, an actuator group 120 including one or more actuators driven under the control of the vehicle control device 110, and a communication device 130 for wirelessly communicating with an external device such as the server 200. The actuator group 120 includes actuators related to the traveling of the vehicle 100, such as actuators of a driving device for accelerating the vehicle 100, actuators of a steering device for changing the traveling direction of the vehicle 100, and actuators of a braking device for decelerating the vehicle 100. The driving device includes a battery, a traveling motor driven by electric power of the battery, and driving wheels rotated by the traveling motor. The actuator of the drive device includes a traveling motor.

The vehicle control device 110 includes a computer including a processor 111, a memory 112, an input/output interface 113, and an internal bus 114. The processor 111, the memory 112, and the input/output interface 113 are bidirectionally communicably connected via an internal bus 114. An actuator group 120 and a communication device 130 are connected to the input/output interface 113. The processor 111 executes the program PG1 stored in the memory 112 to realize various functions including functions as the vehicle control unit 115.

The vehicle control unit 115 controls the actuator group 120 to cause the vehicle 100 to travel. The vehicle control unit 115 can cause the vehicle 100 to travel by controlling the actuator group 120 using the travel control signal received from the server 200. The travel control signal is a control signal for causing the vehicle 100 to travel. In the present embodiment, the travel control signal includes the acceleration and the steering angle of the vehicle 100 as parameters. In other embodiments, the travel control signal may include the speed of the vehicle 100 as a parameter in place of or in addition to the acceleration of the vehicle 100.

The external sensor 300 is a sensor located outside the vehicle 100. The external sensor 300 in the present embodiment is a sensor that captures the vehicle 100 from the outside of the vehicle 100. Specifically, the external sensor 300 is constituted by a camera. The camera as the external sensor 300 captures an image of the vehicle 100 and outputs a captured image as a detection result. The external sensor 300 includes a communication device (not shown), and can communicate with another device such as the server 200 by wired communication or wireless communication.

The external apparatus 350 is an apparatus located outside the vehicle 100. As shown in FIG. 1, in the present embodiment, a plurality of external apparatuses 350 is arranged along the track TR in the factory FC. The external apparatus 350 performs various operations on the vehicle 100. Specifically, the external apparatus 350 in the present embodiment is configured as an assembling robot for assembling components to the vehicle 100.

As illustrated in FIG. 2, the external apparatus 350 includes a communication device 352 and one or more arm portions 351. The communication device 352 can communicate with the server 200 by wired communication or wireless communication. The arm portion 351 is configured as, for example, a vertical articulated type, a horizontal articulated type, an orthogonal type, or a parallel link type robot arm. An end effector corresponding to a component that the external apparatus 350 assembles to the vehicle 100 is attached to the arm portion 351 of each external apparatus 350. For example, the end effector may be configured to be capable of supporting an object by sucking the object, may be configured to be capable of supporting the object by sandwiching the object, or may be configured to be capable of fastening a bolt or a screw. The arm portion 351 includes an encoder as a sensor for detecting a motion state of the arm portion 351.

Each external apparatus 350 may be an interlocked apparatus. The interlocked apparatus is a device interlocked with the vehicle 100. Hereinafter, a state in which the vehicle 100 and the external apparatus 350 are interlocked with each other is also referred to as an interlocked state. In the following description, a state in which the vehicle 100 and the external apparatus 350 are not interlocked is also referred to as a non-interlocked state.

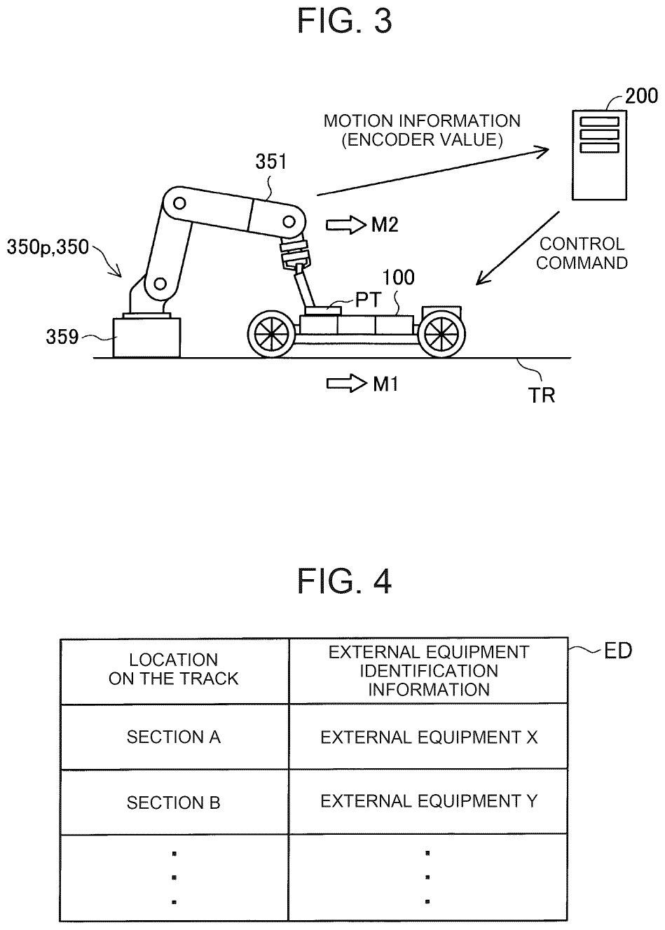

FIG. 3 is a diagram for explaining an interlocked state in the first embodiment. The vehicle 100 and the external apparatus 350 are interlocked with each other by directly or indirectly connecting the vehicle 100 and the external apparatus 350 to each other, and are in an interlocked state. Specifically, the vehicle 100 and the external apparatus 350 are interlocked with each other by supporting the vehicle 100 on the external apparatus 350, fitting or engaging at least a part of the external apparatus 350 with the vehicle 100, supporting the external apparatus 350 with another object fitted or engaged with the vehicle 100, fitting or engaging at least a part of the external apparatus 350 with another object fitted or engaged with the vehicle 100, and the like. FIG. 3 shows a state in which the vehicle 100 and the external apparatus 350p are interlocked with each other via the component PT assembled to the vehicle 100 by the external apparatus 350p. Specifically, in the embodiment of FIG. 3, the component PT is a vehicle seat on which an occupant of the vehicle 100 is seated. The component PT is assembled to the vehicle 100 by fastening fixtures such as bolts and screws for coupling the component PT and the vehicle 100 to each other while being fitted or engaged with the vehicle 100. Fastening of the fixture may be performed using, for example, the arm portion 351 of the arm portion 351 of the interlocked apparatus configured as a double-arm robot that does not grip the component PT. Further, it may be executed by an external apparatus 350 different from the interlocked apparatus, or may be executed by an operator. In addition, the component PT is assembled to the traveling vehicles 100. As described above, by assembling the member with respect to the vehicle 100 while the vehicle 100 is traveling, the vehicle 100 can be manufactured more efficiently than in the case where the member is assembled by stopping the vehicle 100.

In the embodiment of FIG. 3, since the vehicle 100 and the external apparatus 350p are interlocked state with each other, the movement M1 caused by the travel of the vehicle 100 and the movement M2 caused by the movement of the external apparatus 350p are interlocked with each other. When the vehicle 100 and the external apparatus 350p are interlocked state, it can be said that the movement M1 of the vehicle 100 and the movement M2 of the external apparatus 350 are consequently synchronized with each other. Further, when the movement M1 and the movement M2 are interlocked, the position of the vehicle 100 and the position of the external apparatus 350p correspond to each other, and the direction of the vehicle 100 and the direction and the moving direction of the external apparatus 350p correspond to each other. Note that the movement M2 means movement of an interlocking part of the external apparatus 350p that is interlocked with the vehicles 100. For example, as shown in FIG. 3, the external apparatus 350p in the present embodiment is fixed via the base portion 359, and is configured to move the arm portion 351 connected to the base portion 359 without moving the base portion 359. Therefore, the movement M2 indicates the movement of the arm portion 351 instead of the movement of the entire external apparatus 350p. In other embodiments, the external apparatus 350p may not include the base portion 359, and may be configured to move the entire external apparatus 350p in conjunction with the traveling of the vehicles 100, for example. The external apparatus 350p is configured, for example, as a device having a moving wheel, an infinite track, and legs. In this case, the movement M1 of the vehicles 100 and the movement of the entire interlocked apparatus may be interlocked with each other.

It should be noted that in the factory FC, proper sensing of the vehicles 100 by the external sensors 300 may be hindered by obstacles. The obstacle is, for example, an external apparatus 350, various types of devices that differ from the external apparatus 350 in the factory FC, various types of components, and various types of objects such as various types of persons (for example, workers and administrators). Such obstacles, by the external apparatus 350 is located in the vicinity of the vehicle 100, or the external apparatus 350 is located between the vehicle 100 and the external sensor 300, the vehicle 100 may not be properly captured by the external sensor 300. Specifically, in the present embodiment, in the captured image by the external sensor 300, there is a possibility that the vehicle 100 and the obstacle overlap each other or an obstacle is arranged in the vicinity of the vehicle 100. As a result, segmentation results by the detection model DM1 described later may be affected. In particular, in a place where the external apparatus 350 is arranged, that is, in a place where various kinds of work are performed on the vehicle 100, for example, there is a higher probability that the above-described obstacle occurs, and proper detection of the vehicle 100 by the external sensor 300 is more likely to be hindered.

The description is returned to FIG. 2. The server 200 includes a computer including a processor 201, a memory 202, an input/output interface 203, and an internal bus 204. The processor 201, the memory 202, and the input/output interface 203 are bidirectionally communicably connected via an internal bus 204. A communication device 205 for communicating with various devices external to the server 200 is connected to the input/output interface 203. The communication device 205 can communicate with the vehicle 100 by wireless communication, and can communicate with each external sensor 300 by wired communication or wireless communication. The memory 202 stores various types of information including a program PG2, a reference route RR, a detection model DM1, and an external apparatus data ED. The processor 201 executes the program PG2 stored in the memory 202 to realize various functions including functions as the first position acquisition unit 210, the specification unit 215, the motion information acquisition unit 220, the calculation unit 250, and the command generation unit 260.

The first position acquisition unit 210 acquires the first position of the vehicle 100. The first position is used to acquire the second position of the vehicle 100. The second position is a more detailed position than the first position. The first position in the present embodiment is a rough position to the extent that the respective sections in the factory FC can be specified. The first position may be, for example, the position of the external sensor 300 obtained by photographing the vehicle 100 or the position of the vehicle 100 obtained by the area sensor installed in the factory FC. Further, the position may be a position of the vehicle 100 acquired by using the detection result by the external sensor 300. Further, the second position in the present embodiment is represented by X, Y, Z coordinates in the global coordinate system GC of the factory FC. Details of the second position will be described later.

The specification unit 215 specifies an interlocked apparatus. In the present embodiment, the specification unit 215 searches for and specifies the interlocked apparatus by using the external apparatus data ED. The specification unit 215 in the present embodiment can also be said to function as a searching unit that searches for an interlocked apparatus. The search unit in the present embodiment searches the plurality of external apparatuses 350 for the interlocked apparatus by using the external apparatus data ED.

FIG. 4 is a diagram illustrating external apparatus data ED. In the external apparatus data ED, each location in the factory FC and information representing each external apparatus 350 are stored in association with each other. Specifically, the external apparatus data ED stores the location on the track TR in the factory FC and the identification information of the external apparatus 350 in association with each other. The specification unit 215 searches for and specifies the interlocked apparatus from the plurality of external apparatuses 350 by referring to the external apparatus data ED based on the first position information acquired by the first position acquisition unit 210.

The motion information acquisition unit 220 illustrated in FIG. 2 acquires exercise information related to the exercise of the interlocked apparatus. In the present embodiment, the motion information is a detection value by a physical quantity sensor that detects a physical quantity related to the motion of the interlocked apparatus. Hereinafter, the detection value by the physical quantity sensor is also referred to as a physical quantity sensor value. The physical quantity sensor in the present embodiment is an encoder incorporated in the arm portion 351 of the external apparatus 350 as an interlocked apparatus. Further, as illustrated in FIG. 3, the motion information in the present embodiment is an encoder value detected by an encoder. In other embodiments, the physical quantity sensor is not limited to an encoder built in the external apparatus 350, and various sensors may be used. For example, a potentiometer, an acceleration sensor, or a gyro sensor may be used as the physical quantity sensor. Further, various sensors as physical quantity sensors may be built in or externally attached to the external apparatus 350, for example.

The calculation unit 250 illustrated in FIG. 2 calculates at least one of the position and the direction of the vehicle 100 using at least one of the motion information acquired by the motion information acquisition unit 220 and the detection result of the vehicle 100 by the external sensor 300. The vehicle position information is position information that is a basis for generating a travel control signal. In the present embodiment, the vehicle position information includes the position and orientation of the vehicle 100 in the global coordinate system GC of the factory FC. The position of the vehicle 100 included in the vehicle position information corresponds to the above-described second position.

The calculation unit 250 according to the present embodiment calculates the vehicle position information using the motion information when the vehicle 100 is in the interlocked state, and calculates the vehicle position information using the detection result of the vehicle 100 by the external sensor 300 when the vehicle 100 is in the non-interlocked state. Note that the calculation unit 250 may calculate the vehicle position information by using, for example, the traveling start position by the unmanned operation of the vehicle 100 and the vehicle position information previously calculated in addition to the motion information and the detection result of the vehicle 100 by the external sensor 300.

As described above, when the vehicle 100 and the interlocked apparatus are interlocked with each other, the position of the vehicle 100 and the position of the interlocked apparatus correspond to each other, and the direction of the vehicle 100 and the direction and the moving direction of the interlocked apparatus correspond to each other. Therefore, when the vehicle 100 is in the interlocked state, the calculation unit 250 can calculate, for example, the position, the direction, and the moving direction of the interlocked apparatus interlocked with the vehicle 100 based on the motion information, and can calculate the second position and the direction of the vehicle 100 based on the position and the direction of the interlocked apparatus. For example, in the case where the external apparatus 350 includes the base portion 359 as in the present embodiment, the position and the direction of the external apparatus 350 as the interlocked apparatus can be calculated using the position and the motion information of the base portion 359. Further, for example, in another embodiment, when the external apparatus 350 is configured to perform work on the vehicle 100 while reciprocating along a predetermined course, the position of the external apparatus 350 can be calculated using the position of the start point of the course and the motion information. In this case, the moving direction and direction of the external apparatus 350 may be calculated using the motion information or may be calculated based on the traveling direction of the external apparatus 350 in the course. In the case where the guide is installed in the course, it may be calculated based on the extending direction of the guide.

When the vehicle position information is acquired using the detection result of the vehicle 100 by the external sensor 300, the calculation unit 250 detects the external shape of the vehicle 100 from the captured image. The coordinate system of the captured images, that is, the coordinates of the positioning point of the vehicle 100 in the local coordinate system are calculated, and the calculated coordinates are converted into the coordinates in the global coordinate system GC, thereby acquiring the second position of the vehicle 100. The outline of the vehicle 100 included in the captured image can be detected by inputting the captured image into a detection model DM1 using artificial intelligence (AI), for example. The detection model DM1 is prepared in the system 50 or outside the system 50, for example, and stored in the memory 202 of the server 200 in advance. The detection model DM1 may be, for example, a learned machine learning model learned to implement either semantic segmentation or instance segmentation. As the machine learning model, for example, a convolutional neural network (hereinafter, CNN) learned by supervised learning using a learning dataset can be used. The training data set includes, for example, a plurality of training images including the vehicle 100 and a label indicating which of the regions in the training image indicates the vehicle 100 and the regions other than the vehicle 100. When CNN is learned, the parameters of CNN are preferably updated by back propagation so as to reduce the error between the output-result and-label due to the detection model DM1. Further, the calculation unit 250 can acquire the direction of the vehicle 100 by estimating the direction of the vehicle 100 based on the direction of the movement vector of the vehicle 100 calculated from the position change of the feature point of the vehicle 100 between the frames of the captured image by using, for example, the optical flow method.

The command generation unit 260 generates a control command for causing the vehicle 100 to travel by unmanned operation using the vehicle position information calculated by the calculation unit 250, and transmits the control command to the vehicle 100. Specifically, the control command in the present embodiment is the above-described travel control signal. As illustrated in FIG. 3, in the present embodiment, when the vehicle 100 is in an interlocked state, vehicle position information is calculated using an encoder value as motion information, and a control command generated using the calculated vehicle position information is transmitted to the vehicle 100. The control command for causing the vehicle 100 to travel by the unmanned operation may include at least one of a travel control signal and generation information for generating a travel control signal. Accordingly, in other embodiments, the control command may include generated information in place of or in addition to the travel control signal. As the generation information, for example, vehicle position information, a route, and a target position, which will be described later, can be used.

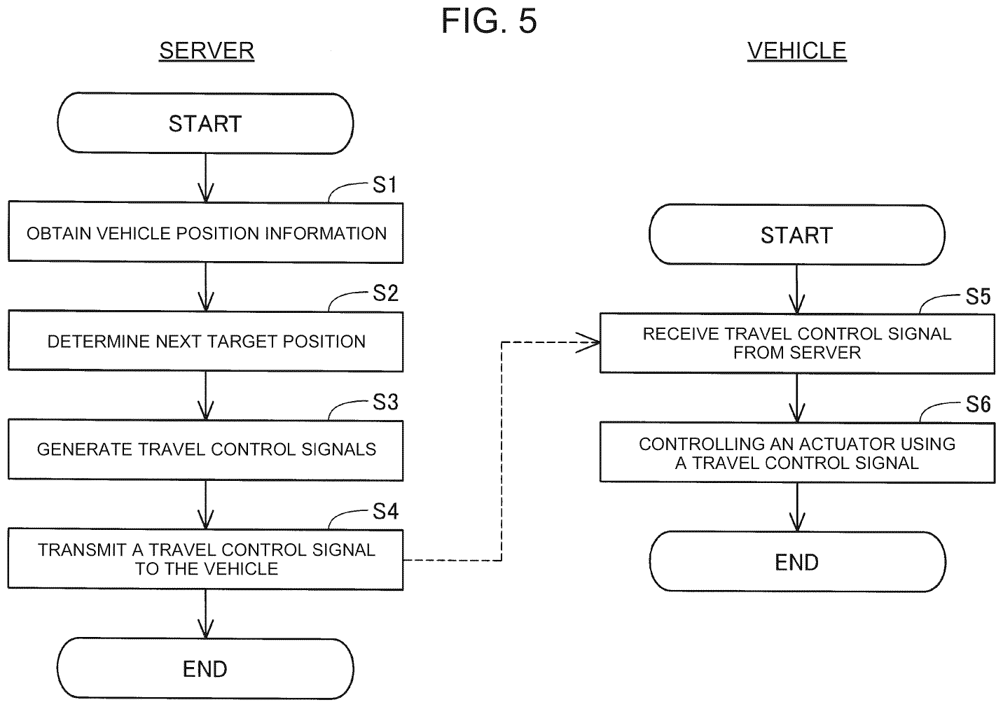

FIG. 5 is a flowchart illustrating a processing procedure of travel control of the vehicle 100 according to the first embodiment. In the processing procedure of FIG. 3, the processor 201 of the server 200 executes the program PG2 to function as the first position acquisition unit 210, the specification unit 215, the motion information acquisition unit 220, the calculation unit 250, and the command generation unit 260 as appropriate. The processor 111 of the vehicle 100 functions as the vehicle control unit 115 by executing the program PG1.

At S1, the processor 201 of the server 200 obtains vehicle-position data.

In S2, the processor 201 of the server 200 determines the target location to which the vehicles 100 should be heading next. In the present embodiment, the target position is represented by the coordinates of X, Y, Z in the global coordinate system GC. In the memory 202 of the server 200, reference route RR that is a route on which the vehicles 100 should travel is stored in advance. The route is represented by a node indicating a starting point, a node indicating a passing point, a node indicating a destination, and a link connecting the respective nodes. The processor 201 uses the vehicle position information and the reference route RR to determine the target position to which the vehicle 100 is to be directed next. The processor 201 determines the target position on the reference route RR ahead of the current position of the vehicles 100.

In S3, the processor 201 of the server 200 generates a travel control signal for causing the vehicle 100 to travel toward the determined target position. The processor 201 acquires the traveling speed from the vehicle 100 and compares the acquired traveling speed with the target vehicle speed. The processor 201 generally determines the acceleration so that the vehicle 100 accelerates when the travel speed is lower than the target speed, and determines the acceleration so that the vehicle 100 decelerates when the travel speed is higher than the target speed. In addition, the processor 201 determines the steering angle and the acceleration so that the vehicle 100 does not deviate from the reference route RR when the vehicle 100 is located on the reference route RR. When the vehicle 100 is not located on the reference route RR, in other words, when the vehicle 100 deviates from the reference route RR, the steering angle and the acceleration are determined so that the vehicle 100 returns to the reference route RR.

In S4, the processor 201 of the server 200 transmits the generated travel control signal to the vehicles 100. The processor 201 repeats acquisition of vehicle position information, determination of a target position, generation of a travel control signal, transmission of a travel control signal, and the like at predetermined intervals.

In S1 to S4 in the present embodiment, specifically, a command generation process to be described later is executed.

In S5, the processor 111 of the vehicle 100 receives the travel control signal transmitted from the server 200. In S6, the processor 111 of the vehicle 100 controls the actuator group 120 using the received travel control signal, thereby causing the vehicle 100 to travel at the acceleration and the steering angle represented by the travel control signal. The processor 111 repeatedly receives the travel control signal and controls the actuator group 120 at a predetermined cycle. According to the system 50 of the present embodiment, the vehicle 100 can be driven by remote control, and the vehicle 100 can be moved without using a conveyance facility such as a crane or a conveyor.

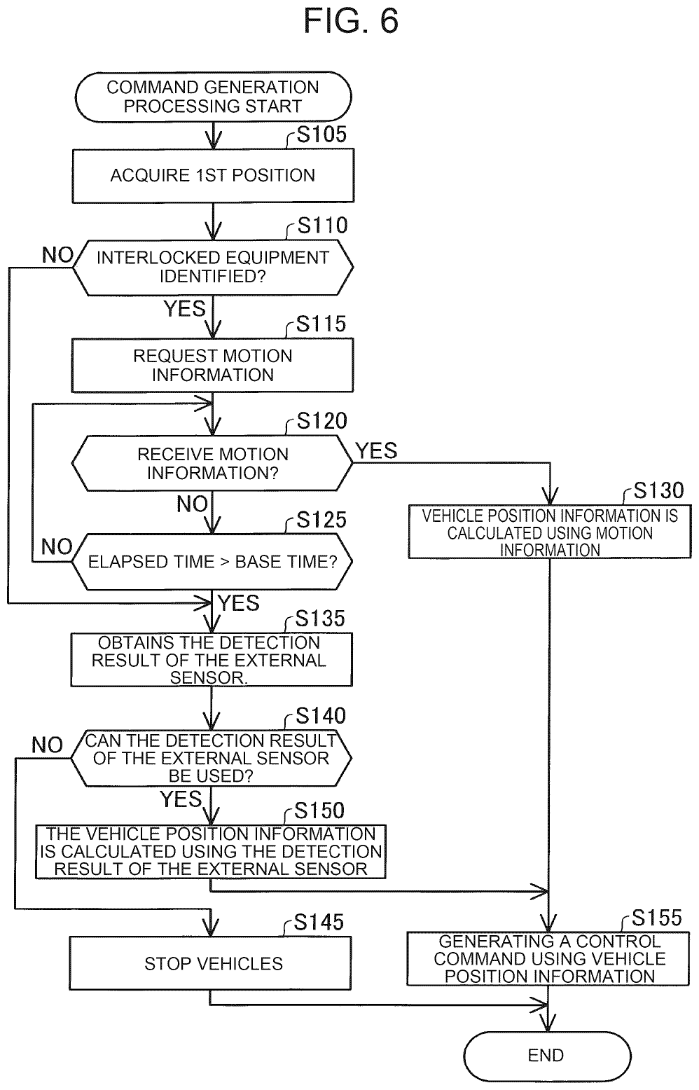

FIG. 6 is a flowchart illustrating a processing procedure of the command generation processing according to the present embodiment. The command processing in FIG. 6 is executed by the processor 201 of the server 200 at predetermined time intervals, for example.

In S105, the first position acquisition unit 210 acquires the first position of the vehicle 100.

In S110, the specification unit 215 performs a search for an interlocked apparatus, and determines whether or not the interlocked apparatus is identified. In S110, the specification unit 215 refers to the external apparatus data ED based on the first position acquired by S105, and identifies the external apparatus 350 associated with the location represented by the first position as the interlocked apparatus. When the interlocked apparatus is identified in this way, the specification unit 215 determines that the interlocked apparatus has been identified. On the other hand, when none of the external apparatus 350 is associated with the location represented by the first location in S110, the specification unit 215 determines that the interlocked apparatus has not been identified.

Note that, when the vehicle 100 is in the interlocked state immediately before the command generation process is started, the fact that the interlocked apparatus is not specified by S110 means that the interlocked state of the vehicle 100 is released. That is, in this case, it means that the interlocked state transitions to the non-interlocked state. Further, when the vehicle 100 is in the interlocked state immediately before the command generation process is started, the interlocked apparatus is identified by S110, which means that the interlocked state of the vehicle 100 is maintained without being released.

When the interlocked apparatus is identified by S110, the calculation unit 250 requests the interlocked apparatus to transmit the motion information in S115. In S120, the calculation unit 250 determines whether or not motion information has been received from the interlocked apparatus. When the motion information is not received by S120, the calculation unit 250 determines whether or not the elapsed time since S115 is executed exceeds a predetermined reference time in S125. When the elapsed time is equal to or less than the reference time in S125, the calculation unit 250 returns the process to S120. That is, the calculation unit 250 receives the motion information from the interlocked apparatus until the reference period elapses after S115 is executed.

When the motion information is received by S120, the calculation unit 250 calculates the vehicle position information by using the motion information in S130.

When the interlocked apparatus is not specified in S110 and the elapsed time exceeds the reference time in S125, the calculation unit 250 acquires the detection result by the external sensor 300 from the external sensor 300 in S135. That is, in S135 according to the present embodiment, captured images are acquired.

In S140, the calculation unit 250 determines whether or not the detection result obtained by S135 can be used to acquire the vehicle-position information. Specifically, in S140 according to the present embodiment, the calculation unit 250 determines whether or not the vehicles 100 are included in the captured images acquired by S135. In S140, the calculation unit 250 may determine whether or not the vehicles 100 are included in the captured images using various detecting algorithms. For example, the determination may be made using a detection model DM1, or may be made using a machine-learning model that differs from the detection model DM1. In another embodiment, in S140, for example, when the area indicating the vehicle 100 is included in the captured image at an area ratio equal to or larger than a predetermined value, the calculation unit 250 may determine that the captured image can be used to acquire vehicle position information.

If S140 determines that the external sensor 300 is not enabled detection result, the command generation unit 260 stops the vehicle 100 in S145. In S145 according to the present embodiment, the command generation unit 260 generates and outputs a control command for braking the vehicles 100. That is, in the present embodiment, when the vehicle 100 is not included in the captured images in S140, the command generation unit 260 generates a travel control signal for braking the vehicle 100 in S145, and transmits the generated travel control signal to the vehicle 100.

When it is determined that the detection result by the external sensor 300 is usable in S140, the calculation unit 250 calculates the vehicle position information by using the detection result by the external sensor 300 in S150. That is, in the present embodiment, when the vehicle 100 is included in the captured image in S140, the calculation unit 250 calculates the vehicle position information using the captured image including the vehicle 100 in S150. Further, in the present embodiment, it can be said that the vehicle position information is calculated using the detection result of the vehicle by the external sensor 300 when the interlocked apparatus is not specified or when the interlocked state transitions to the non-interlocked state.

In S155, the command generation unit 260 generates and outputs a control command using the calculated vehicle position information. That is, in S155 according to the present embodiment, the command generation unit 260 generates a travel control signal as a control command by using the vehicle position information calculated by S130 or S150, and transmits the generated travel control signal to the vehicle 100. The vehicle control unit 115 controls the actuator group 120 by using the received control command, thereby causing the vehicle 100 to travel.

Note that the above-described command generation processing may be started after the interlocked state of the vehicle 100 is released, that is, after the interlocked state transitions to the non-interlocked state. In S110 of the command generation process started after the interlocked state transitions to the non-interlocked state, the interlocked apparatus is newly searched for the vehicles 100. Therefore, in the present embodiment, it can be said that the search for the interlocked apparatus is newly executed when the interlocked state transitions to the non-interlocked state. Further, in the present embodiment, when the interlocked apparatus is not newly specified by the search executed when the interlocked state transitions to the non-interlocked state, S140 and S150 are executed. Then, the vehicle position information is calculated using the detection result by the external sensor 300.

According to the server 200 in the present embodiment described above, the vehicle position information is calculated using the motion information of the interlocked apparatus that is interlocked with the vehicle 100. Therefore, even in a situation where proper detection of the vehicle 100 by the external sensor 300 can be hindered, the position and orientation of the vehicle 100 can be appropriately acquired.

Further, in the present embodiment, since the motion information is an encoder value built in the external apparatus 350, the position and the direction of the vehicle 100 can be acquired with higher accuracy.

Further, in the present embodiment, motion information is acquired for the interlocked apparatus specified by the specification unit 215. Therefore, for example, it is possible to acquire the motion information of the interlocked apparatus more appropriately as compared with a case where the motion information is acquired from each external apparatus 350 without specifying the interlocked apparatus.

In the present embodiment, when the interlocked state transitions to the non-interlocked state, the vehicle position information is calculated based on the detection result of the vehicle 100 by the external sensor 300. Therefore, not only the vehicle position information can be appropriately acquired in the interlocked state, but also the vehicle position information can be appropriately acquired even when the interlocked state transitions to the non-interlocked state.

Further, in the present embodiment, when the interlocked state transitions to the non-interlocked state, a search for the interlocked apparatus is newly executed. Therefore, even when the interlocked state transitions to the non-interlocked state, it is possible to newly search for the interlocked apparatus that is interlocked with the vehicle 100 and calculate the vehicle position information using the motion information of the searched interlocked apparatus.

Further, in the present embodiment, when the interlocked apparatus is not newly specified by the search in the case where the interlocked state transitions to the non-interlocked state, the vehicle position information is calculated using the detection result of the vehicle 100 by the external sensor 300. Therefore, even when the interlocked apparatus is not newly specified in the search in the case where the interlocked state transitions to the non-interlocked state, the vehicle position information can be appropriately acquired.

Further, in the present embodiment, the interlocked apparatus can be identified by using the external apparatus data ED stored in the memory 202. In particular, in the present embodiment, the interlocked apparatus can be identified by referring to the external apparatus data ED based on the first position, and the vehicle position information including the second position that is more detailed than the first position can be calculated based on the identified motion information of the interlocked apparatus. Therefore, the vehicle position information can be calculated more easily. Further, in the present embodiment, when the interlocked apparatus is not specified as a result of referring to the external apparatus data ED based on the first position, the vehicle position information including the second position can be calculated using the detection result of the vehicle 100 by the external sensor 300. Therefore, the vehicle position information can be appropriately acquired in both the interlocked state and the non-interlocked state by a simpler method.

### B. Second Embodiment

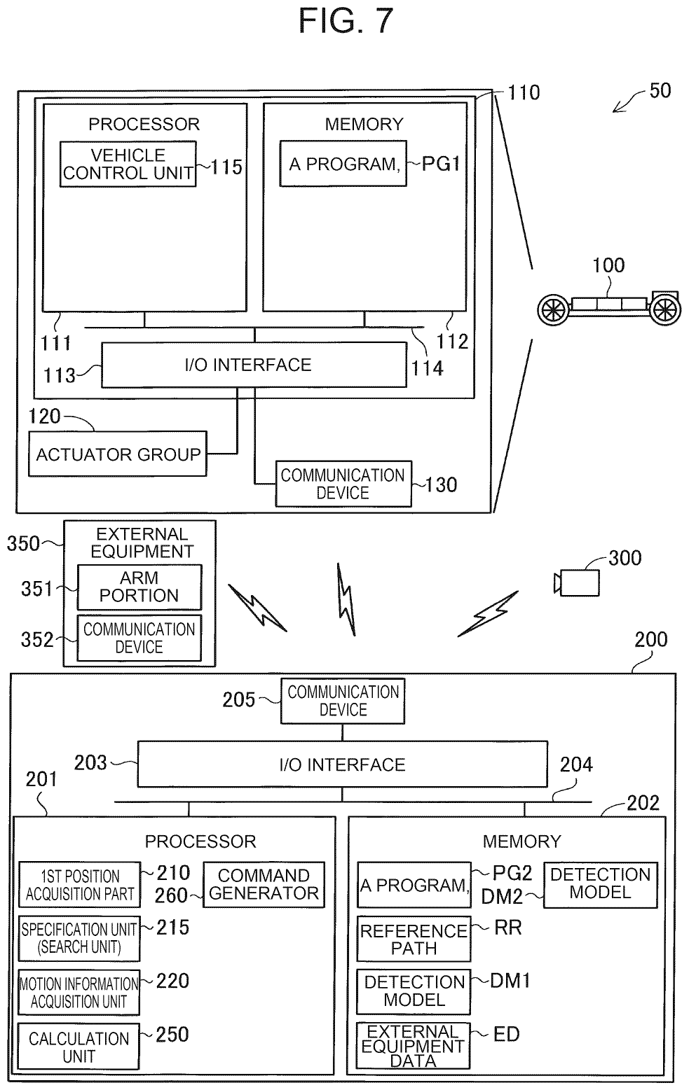

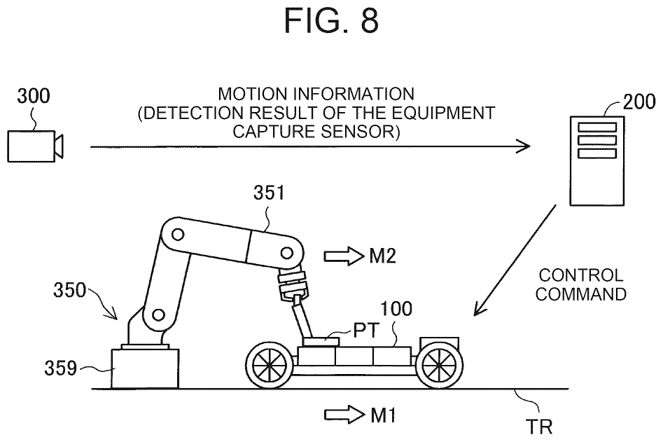

FIG. 7 is a block diagram illustrating a configuration of the system 50 according to the second embodiment. FIG. 8 is a diagram for explaining an interlocked state in the second embodiment. In the present embodiment, unlike the second embodiment, the motion information acquisition unit 220 acquires, as the motion information, not a physical quantity sensor value but a detection result of the external apparatus 350 by an apparatus capture sensor described later. Of the configurations of the system 50 and the server 200 in the second embodiment, the same points as those in the first embodiment are not particularly described.

The apparatus capture sensor is a sensor located outside the external apparatus 350. The apparatus capture sensor captures the external apparatus 350 from the outside of the external apparatus 350. In the present embodiment, an external sensor 300 is used as the apparatus capture sensor. That is, the device capturing sensor in the present embodiment is configured as a camera, captures an image of the external apparatus 350, and outputs a captured image including the external apparatus 350 as motion information. Then, the motion information acquisition unit 220 in the present embodiment acquires, as the motion information, a detection result by the apparatus capture sensor, that is, an image captured by the apparatus capture sensor. As a result, as shown in FIG. 8, in the present embodiment, when the vehicle 100 is in the interlocked state, the vehicle position information is calculated using the detection result of the interlocked apparatus by the apparatus capture sensor as the motion information. A control command generated by using the calculated vehicle position information is transmitted to the vehicle 100.

In the present embodiment, when the vehicle position information is acquired using the motion information, first, the calculation unit 250 calculates at least one of the position and the direction of the interlocked apparatus using the detection result of the interlocked apparatus by the apparatus capture sensor. Specifically, the calculation unit 250 detects the external shape of the interlocked apparatus from the captured image by the apparatus capture sensor, and detects the coordinates of the positioning point of the interlocked apparatus in the local coordinate system. The position of the interlocked apparatus can be acquired by converting the calculated coordinates into coordinates in the global coordinate system GC. A detection model DM2 described later can be used to detect the external shape of the interlocked apparatus. From the viewpoint of appropriately performing the detection of the external shape by the detection model DM2, it is preferable that the captured image by the apparatus capture sensor includes a part of the interlocked apparatus in which the relative position change and the angular change with respect to the vehicle 100 in the interlocked state are smaller. For example, in the present embodiment, it is preferable that the captured image includes a portion of the arm portion 351 that is different from the end effector. Further, the calculation unit 250 can acquire the movement vector of the interlocked apparatus and the direction of the interlocked apparatus from the position change of the feature point of the interlocked apparatus between frames of the captured image by using, for example, the optical flow method. The calculation unit 250 can acquire the vehicle position information by using the position, the direction, and the moving direction of the interlocked apparatus calculated in this manner.

The memory 202 according to the present embodiment stores detection model DM2. The detection model DM2 is configured as, for example, a machine-learning model that utilizes AI, substantially the same as the detection model DM1. However, unlike the detection model DM1, the detection model DM2 is a machine-learning model for detecting the external shape of the external apparatus 350 included in the captured images. As the training data set for learning the detection model DM2, for example, a plurality of training images including the external apparatus 350 and labels indicating which of an area indicating the external apparatus 350 and an area indicating other than the external apparatus 350 is included in each area in each training image are included. In other embodiments, the machine learning model for detecting the external shape of the external apparatus 350 may be prepared for each external apparatus 350 or for each type of the external apparatus 350, for example. In addition, the detection model DM1 may be configured to detect not only the external shape of the vehicles 100 included in the imaging but also the external shape of the external apparatus 350 included in the captured images.

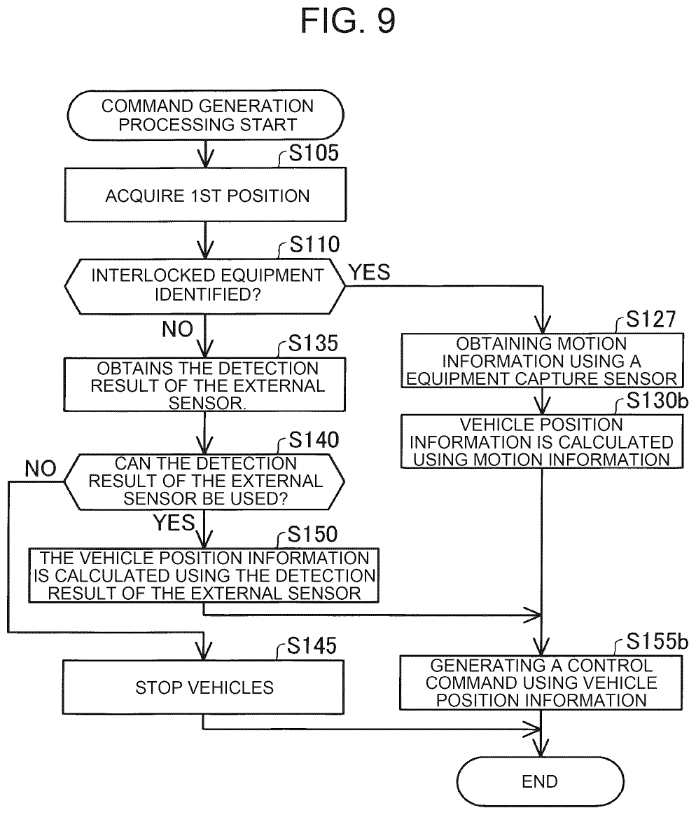

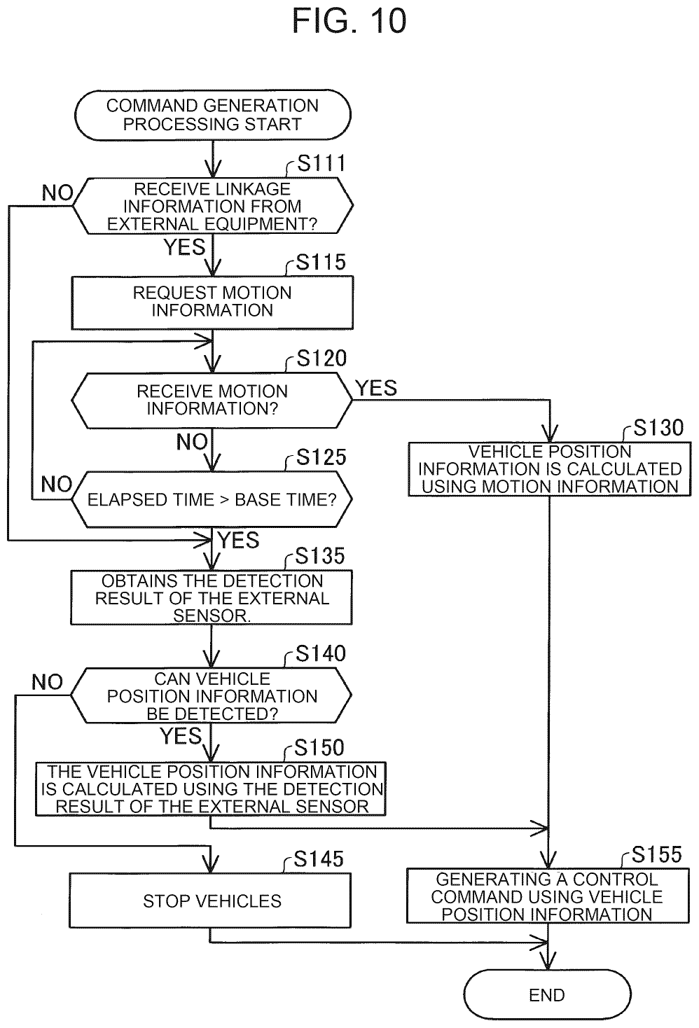

FIG. 9 is a flowchart of a command generation process in the second embodiment. In FIG. 9, the same steps as in FIG. 6 are denoted by the same reference numerals as in FIG. 6.

As illustrated in FIG. 9, in the present embodiment, when the interlocked apparatus is specified by S110, S127 and S130b are executed in place of S130 from S115 in FIG. 6. In S127, the calculation unit 250 acquires, as the motion information, the detection result by the apparatus capturing sensor. That is, in S127 according to the present embodiment, the calculation unit 250 acquires captured images including the external apparatus 350 as motion information.

In S130b, the calculation unit 250 calculates the vehicle position information using the motion information acquired by S127. In S155b, the command generation unit 260 generates a travel control signal as a control command by using vehicle position information calculated by S130b or S150, and transmits the generated travel control signal to the vehicle 100.

The server 200 according to the present embodiment described above also calculates the vehicle position information by using the motion information of the interlocked apparatus that is interlocked with the vehicle 100. Therefore, even in a situation where proper detection of the vehicle 100 by the external sensor 300 can be hindered, the position and orientation of the vehicle 100 can be appropriately acquired. In particular, in the present embodiment, since the vehicle position information is calculated using the detection result by the apparatus capture sensor, the vehicle position information can be calculated without causing the external apparatus 350 or the physical quantity sensor to communicate with the server 200.

Further, in the present embodiment, the external sensor 300 for detecting the vehicle 100 is also used as the apparatus capturing sensor. Therefore, for example, compared to the case where the apparatus capture sensor is provided separately from the external sensor 300, the cost required for constructing the system 50 can be reduced.

### C. Third Embodiment

FIG. 10 is a flowchart of a command generation process according to the third embodiment. In FIG. 10, the same steps as in FIG. 6 are denoted by the same reference numerals as in FIG. 6. In the third embodiment, unlike the first embodiment and the second embodiment, the interlocked apparatus is specified without using the external apparatus data ED. In addition, the specification unit 215 in the present embodiment does not function as a searching unit. Of the configurations of the system 50 and the server 200 in the third embodiment, the same points as those in the first embodiment are not particularly described.

In S111, the specification unit 215 determines whether or not interlock data has been received from the external apparatus 350. The interlock information is information indicating that the external apparatus 350 is interlocked with the vehicle 100, and is, for example, identification information of the external apparatus 350. In the present embodiment, the external apparatus 350 as the interlocked apparatus is configured to transmit the interlocking information at predetermined time intervals. When the linkage information is received from an external apparatus 350, the specification unit 215 specifies the external apparatus 350 as the linkage device. When interlocking information is not received from any external apparatus 350, the specification unit 215 determines that the external apparatus 350 has not been specified. As described above, the specification unit 215 in the present embodiment does not function as a searching unit.

The server 200 according to the present embodiment described above also calculates the vehicle position information by using the motion information of the interlocked apparatus that is interlocked with the vehicle 100. Therefore, even in a situation where proper detection of the vehicle 100 by the external sensor 300 is hindered, the position and orientation of the vehicle 100 can be appropriately acquired. In particular, in the present embodiment, the interlocked apparatus can be specified more easily without using the external apparatus data ED. In the present embodiment, the external apparatus data ED may not be stored in the memory 202.

### D. Fourth Embodiment

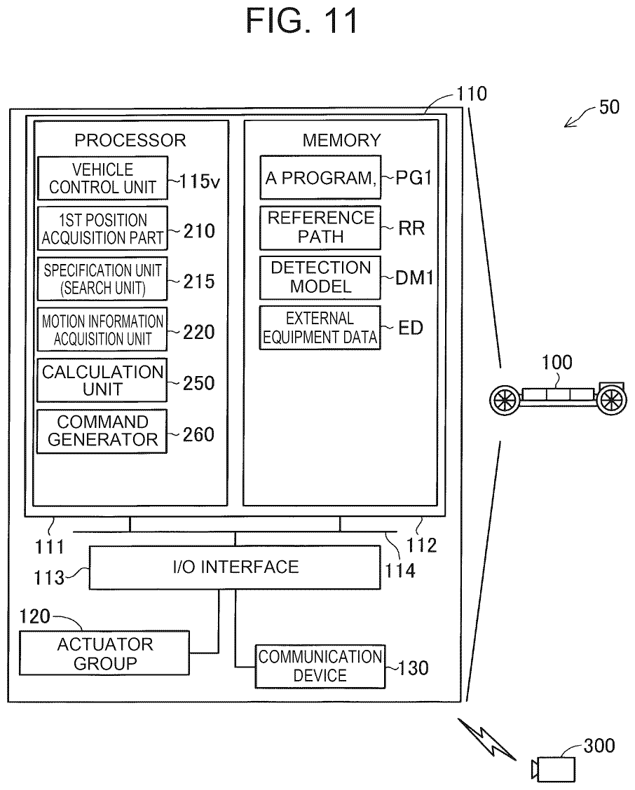

FIG. 11 is a block diagram showing a configuration of the system 50 according to the fourth embodiment. Unlike the first embodiment, the system 50 in the present embodiment does not include the server 200. Further, the vehicle according to the present embodiment can travel by autonomous control of the vehicle. Since the device configuration of the vehicle in the present embodiment is the same as that of the vehicle 100 in the first embodiment, the vehicle in the present embodiment is also referred to as the vehicle 100 for convenience. Of the configurations of the system 50 and the vehicle 100 according to the fourth embodiment, portions not specifically described are the same as those of the first embodiment.

In the present embodiment, the communication device 130 of the vehicle 100 can communicate with the external sensor 300. The processor 111 of the vehicle control device 110 executes the program PG2 stored in the memory 112, thereby functioning as the vehicle control unit 115v, the first position acquisition unit 210, the specification unit 215, the motion information acquisition unit 220, the calculation unit 250, and the command generation unit 260. The vehicle control unit 115v controls the actuator group 120 by using the travel control signal generated by the vehicle 100, so that the vehicle 100 can travel by autonomous control. In addition to the program PG1, the memory 112 stores a reference route RR, a detection model DM1, and an external apparatus data ED. The vehicle control device 110 according to the fourth embodiment corresponds to a “device” according to the present disclosure.

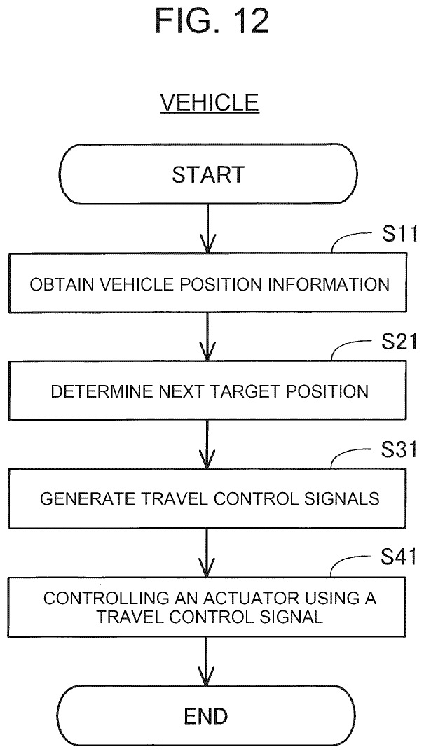

FIG. 12 is a flowchart illustrating a processing procedure of travel control of the vehicle 100 according to the fourth embodiment. At S11, the processor 111 of the vehicle 100 obtains vehicle position data. In S21, the processor 111 determines a target position to which the vehicles 100 should be heading next. In S31, the processor 111 generates a travel control signal for causing the vehicles 100 to travel toward the determined target position. In S41, the processor 111 controls the actuator of the vehicle 100 by using the generated travel control signal, thereby causing the vehicle 100 to travel in accordance with the parameter represented by the travel control signal. The processor 111 repeats acquisition of vehicle position information, determination of a target position, generation of a travel control signal, and control of an actuator at a predetermined cycle. According to the system 50 in the present embodiment, the vehicle 100 can be caused to travel by autonomous control of the vehicle 100 without remotely controlling the vehicle 100 by the server 200.

In S904 from S901 in the present embodiment, the same command generation process as in FIG. 6 is executed. The command generation processing is executed by the processor 111 of the vehicle control device 110 at predetermined time intervals, for example.

In the present embodiment, the steps in FIG. 6 are executed by the processor 111. For example, in S155 according to the present embodiment, the command generation unit 260 of the vehicle 100 generates and outputs a travel control signal as a control command using the vehicle position information calculated by S130 or S150. The vehicle control unit 115v controls the actuator group 120 by using the control command generated by the vehicle 100 in this way, thereby causing the vehicle 100 to travel.

The vehicle control device 110 according to the present embodiment described above also calculates the vehicle position information by using the motion information of the interlocked apparatus that is interlocked with the vehicle 100. Therefore, even in a situation where proper detection of the vehicle 100 by the external sensor 300 is hindered, the position and orientation of the vehicle 100 can be appropriately acquired.

Note that, in a mode in which the vehicle 100 travels by autonomous control as in the present embodiment, for example, a command generation process may be executed in the same manner as in the second and third embodiments. When the command generation process is executed in the same manner as in the third embodiment in a mode in which the vehicles 100 travel by autonomous control, the external apparatus data ED may not be stored in the memory 112. Further, in a mode in which the vehicle 100 travels by autonomous control, for example, the system 50 may be provided with the server 200.

### E. Other Embodiments

(E1) In each of the above-described embodiments, the motion information acquisition unit 220 acquires the exercise information for the external apparatus 350 identified as the interlocked apparatus by the specification unit 215. On the other hand, the motion information acquisition unit 220 may acquire the exercise information for each external apparatus 350, instead of acquiring the exercise information for the interlocked apparatus specified by the specification unit 215, for example. In this case, the calculation unit 250 may calculate the vehicle position information using the motion information about the interlocked apparatus among the acquired motion information. Further, for example, the external apparatus 350 interlocked with the vehicle 100 may transmit the motion information to the server 200, the motion information acquisition unit 220 may acquire the transmitted motion information, and the calculation unit 250 may calculate the vehicle position information using the acquired motion information. When the interlocked apparatus is not specified as described above, the vehicle 100 or the server 200 may not include the specification unit 215.
(E2) In the above-described embodiment, the calculation unit 250 calculates the vehicle position information by using the detection result of the vehicle 100 by the external sensor 300 when the interlocked state is released, but it is not necessary to do so. For example, the calculation unit 250 may not calculate the vehicle position information when the interlocked state is released, and the command generation unit 260 may generate a control command for causing the vehicle 100 to travel and a control command for braking without using the vehicle position information. In this case, the command generation unit 260 may generate a predetermined control command regardless of the vehicle position information, for example.
(E3) In the above-described embodiment, the specification unit 215 newly executes the search for the interlocked apparatus when the interlocked state of the vehicle 100 is released, but this is not necessary. For example, when the interlocked state of the vehicle 100 is released, the calculation unit 250 may calculate the vehicle position information using the detection result of the external sensor 300 without newly executing the search for the interlocked apparatus. In addition, when the interlocked state of the vehicle 100 is released, the command generation unit 260 may generate a control command for causing the vehicle 100 to travel without using the vehicle position information or a control command for braking.
(E4) In each of the above-described embodiments, when the interlocked apparatus is not specified by the search executed when the interlocked state is released, the calculation unit 250 calculates the vehicle position information using the detection result of the vehicle 100 by the external sensor 300, but it is not necessary to do so. For example, when the interlocked apparatus is not specified by the above-described search, the calculation unit 250 may not calculate the vehicle position information, and the command generation unit 260 may generate a control command for driving the vehicle 100 and a control command for braking without using the vehicle position information.
(E5) In each of the above-described embodiments, the motion information acquisition unit 220 acquires the physical quantity sensor value as the exercise information when the physical quantity sensor value can be acquired from the interlocked apparatus under a predetermined condition. In a case where the physical quantity sensor value cannot be acquired under a predetermined condition, the detection result by the apparatus capture sensor may be acquired as motion information. The predetermined condition is, for example, that the elapsed time after requesting the motion information from the interlocked apparatus does not exceed the reference time. Specifically, when the elapsed time exceeds the reference time in S125 of FIG. 6, the motion information acquisition unit 220 may acquire, as the motion information, the detection result by the apparatus capturing sensor. Then, the calculation unit 250 may calculate the vehicle position information using the detection result obtained by the apparatus capture sensor.
(E6) In the second embodiment, the machine learning model for detecting the external shape of the external apparatus 350 may be configured to detect the external shape of the component assembled to the vehicle 100 by the external apparatus 350, for example. In this way, the calculation unit 250 can calculate the position and the direction of the component based on the external shape of the component detected by the machine learning model. Since each component is usually assembled to a predetermined position of the vehicle 100 in a predetermined direction, the calculation unit 250 can calculate the vehicle position information using the position and the direction of the component calculated based on the external shape of the component in addition to the motion information. For example, the calculation unit 250 may calculate the position of the interlocked apparatus using the motion information, and may calculate the second position of the vehicle 100 based on the calculated position. Further, the calculation unit 250 may calculate the direction of the vehicle 100 based on the direction of the component calculated based on the external shape of the component. In this case, for example, the calculation unit 250 may directly calculate the direction of the vehicle 100 from the direction of the component calculated based on the external shape of the component, or may calculate the direction of the interlocked apparatus from the direction of the component and calculate the direction of the vehicle 100 based on the calculated direction of the interlocked apparatus.
(E7) In each of the above-described embodiments, the vehicle 100 and the server 200 may be provided with a determination unit as a functional unit that determines whether or not the interlocked state of the vehicle 100 has been released, that is, whether or not the interlocked state has transitioned to the non-interlocked state. The determination unit determines that the interlocked state has transitioned to the non-interlocked state, for example, when the information indicating that the interlock with the vehicle 100 has been released is received from the interlock apparatus. In a mode in which the determination unit is provided in the vehicle 100, the server 200, or the like, the process of detecting the vehicle position information using the detection result of the vehicle 100 by the external sensor 300 when the interlocked state transitions to the non-interlocked state or the process of newly searching for the interlocked apparatus when the interlocked state transitions to the non-interlocked state may be started using the determination result by the determination unit as a trigger.
(E8) In each of the above-described embodiments, in the system 50, various functional units such as the first position acquisition unit 210, the specification unit 215, the motion information acquisition unit 220, the calculation unit 250, and the command generation unit 260 may be provided in the vehicle 100. In this case, as described in the fourth embodiment, all of the first position acquisition unit 210, the specification unit 215, the motion information acquisition unit 220, the calculation unit 250, and the command generation unit 260 may be provided in the vehicle 100, or some of these functional units may be provided in the vehicle 100. In the system 50, some or all of these functional units may be provided in a device outside the server 200 and the vehicle 100.
(E9) In each of the above embodiments, the external sensor 300 is a camera. On the other hand, the external sensor 300 may not be a camera, and may be, for example, a distance measuring device. The ranging device may be, for example, a Light Detection and Ranging (LiDAR) or a stereo camera. In this case, the detection result output by the external sensor 300 may be three-dimensional point cloud data representing the vehicle 100. In this case, the server 200 or the vehicle 100 may acquire the vehicle position information by template matching using three-dimensional point cloud data as a detection result and reference point cloud data prepared in advance.
(E10) In the first embodiment, the server 200 executes processing from acquisition of vehicle position information to generation of a travel control signal. On the other hand, at least a part of the processing from the acquisition of the vehicle position information to the generation of the travel control signal may be executed by the vehicle 100. For example, the following forms (1) to (3) may be used.
(1) The server 200 may acquire the vehicle position information, determine a target position to which the vehicle 100 should be heading next, and generate a route from the current position of the vehicle 100 represented by the acquired vehicle position information to the target position. The server 200 may generate a route to a target position between the current location and the destination, or may generate a route to the destination. The server 200 may transmit the generated route to the vehicle 100. The vehicle 100 may generate a travel control signal so that the vehicle 100 travels on the route received from the server 200, and control the actuator group 120 using the generated travel control signal.
(2) The server 200 may acquire the vehicle position information and transmit the acquired vehicle position information to the vehicle 100. The vehicle 100 may determine a target position to which the vehicle 100 should be directed next, generate a route from the current position of the vehicle 100 represented by the received vehicle position information to the target position, generate a travel control signal so that the vehicle 100 travels on the generated route, and control the actuator group 120 using the generated travel control signal.
(3) In the above embodiments (1) and (2), an internal sensor may be mounted on the vehicle 100, and a detection result output from the internal sensor may be used for at least one of generation of a route and generation of a travel control signal. The internal sensor is a sensor mounted on the vehicle 100. The internal sensor may include, for example, a sensor that detects a motion state of the vehicle 100, a sensor that detects a motion state of each part of the vehicle 100, and a sensor that detects an environment around the vehicle 100. Specifically, the inner sensor may include, for example, a camera, a LiDAR, a millimeter-wave radar, an ultrasonic sensor, a GPS sensor, an accelerometer, a gyroscope, and the like. For example, in the embodiment (1), the server 200 may acquire the detection result of the internal sensor and reflect the detection result of the internal sensor in the path when generating the path. In the aspect (1), the vehicle 100 may acquire the detection result of the internal sensor and reflect the detection result of the internal sensor in the travel control signal when generating the travel control signal. In the aspect (2), the vehicle 100 may acquire the detection result of the internal sensor and reflect the detection result of the internal sensor in the path when generating the path. In the aspect (2), the vehicle 100 may acquire the detection result of the internal sensor and reflect the detection result of the internal sensor in the travel control signal when generating the travel control signal.
(E11) In the fourth embodiment, an internal sensor may be mounted in the vehicle 100, and a detection result output from the internal sensor may be used for at least one of generation of a route and generation of a travel control signal. For example, the vehicle 100 may acquire the detection result of the internal sensor and reflect the detection result of the internal sensor on the route when generating the route. The vehicle 100 may acquire the detection result of the internal sensor and reflect the detection result of the internal sensor in the travel control signal when generating the travel control signal.
(E12) In the first embodiment, the server 200 automatically generates a travel control signal to be transmitted to the vehicle 100. On the other hand, the server 200 may generate a travel control signal to be transmitted to the vehicle 100 in accordance with an operation of an external operator located outside the vehicle 100. For example, an external operator may operate a control device including a display for displaying a captured image output from the external sensor 300, a steering for remotely controlling the vehicle 100, an accelerator pedal, a brake pedal, and a communication device for communicating with the server 200 through wired communication or wireless communication, and the server 200 may generate a travel control signal corresponding to an operation applied to the control device. In this case, the vehicle position information calculated by the calculation unit 250 may be used, for example, to correct a parameter determined by an operation of an external operator or to correct a parameter of a draft control signal.
(E13) The vehicle 100 may be manufactured by combining a plurality of modules. A module refers to a unit composed of one or more components grouped according to the configuration and function of the vehicle 100. For example, the platform of the vehicle 100 may be manufactured by combining a front module that constitutes a front portion of the platform, a central module that constitutes a central portion of the platform, and a rear module that constitutes a rear portion of the platform. The number of modules constituting the platform is not limited to three, and may be two or less or four or more. In addition to or instead of the platform, a different part of the vehicle 100 from the platform may be modularized. Further, the various modules may include any exterior parts such as bumpers and grills, and any interior parts such as sheets and consoles. In addition, not only the vehicle 100 but also a moving body of an arbitrary mode may be manufactured by combining a plurality of modules. Such a module may be manufactured, for example, by joining a plurality of parts by welding, a fixture, or the like, or may be manufactured by integrally molding at least a part of the module as one part by casting. Molding techniques for integrally molding at least a portion of a module as one part are also referred to as gigacasts or megacasts. By using the gigacast, each part of the moving body, which has been conventionally formed by joining a plurality of parts, can be formed as one part. For example, the front module, the central module, and the rear module described above may be manufactured using gigacast.
(E14) Transporting the vehicle 100 by using the traveling of the vehicle 100 by the unmanned operation is also referred to as “self-propelled conveyance”. A configuration for realizing self-propelled conveyance is also referred to as a “vehicle remote control autonomous traveling conveyance system”. Further, a production method of producing the vehicle 100 by using self-propelled conveyance is also referred to as “self-propelled production”. In self-propelled manufacturing, for example, at least a part of conveyance of the vehicle 100 is realized by self-propelled conveyance in a factory FC that manufactures the vehicle 100.
(E15) In the above embodiment, the system 50 is used in a factory FC, but is not limited thereto. For example, the system 50 may be used in automatic valley parking. In this case, the external apparatus 350 may be, for example, a device for charging the battery of the vehicle 100 while the vehicle 100 is traveling.
(E16) In each of the above-described embodiments, some or all of the functions and processes implemented in software may be implemented in hardware. In addition, some or all of the functions and processes implemented in hardware may be implemented in software. For example, various circuits such as an integrated circuit and a discrete circuit may be used as hardware for realizing various functions in the above-described embodiments.

The present disclosure is not limited to the above-described embodiments, and can be realized with various configurations without departing from the spirit thereof. For example, the technical features in the embodiments corresponding to the technical features in the respective embodiments described in the Summary can be appropriately replaced or combined in order to solve some or all of the above-described problems or to achieve some or all of the above-described effects. In addition, if the technical features are not described as essential in the present specification, they can be deleted as appropriate.

What is claimed is:

1. A device comprising:
a motion information acquisition unit that acquires motion information related to a motion state of an apparatus interlocked with a moving body that is movable by an unmanned operation; and
a calculation unit that calculates at least one of a position and an orientation of the moving body by using the acquired motion information.

2. The device according to claim 1, further comprising a specification unit that specifies the apparatus, wherein the motion information acquisition unit acquires the motion information for the apparatus specified by the specification unit.

3. The device according to claim 1, wherein the calculation unit calculates at least one of the position and the orientation of the moving body by using a detection result of the moving body by an external sensor positioned outside the moving body when an interlocked state in which the apparatus and the moving body are interlocked transitions to a non-interlocked state in which the apparatus and the moving body are not interlocked.

4. The device according to claim 1, further comprising a search unit that executes a search of an apparatus that moves interlocked with the moving body when an interlocked state in which the apparatus and the moving body are interlocked transitions to a non-interlocked state in which the apparatus and the moving body are not interlocked.

5. The device according to claim 4, wherein the calculation unit calculates at least one of the position and the orientation of the moving body by using a detection result of the moving body by an external sensor positioned outside the moving body when an apparatus that moves interlocked with the moving body is not specified by the search.
